(19) United States
(12) Patent Application Publication
(10) Pub. No.: US 2019/0086217 A1
(43) Pub. Date: Mar. 21, 2019

(54) METHOD AND APPARATUS FOR ROUTE PLANNING ACCOMODATING DATA TRANSFER

(71) Applicant: FORD GLOBAL TECHNOLOGIES, LLC, Dearborn, MI (US)

(72) Inventors: Samer IBRAHIM, Dearborn, MI (US); Sushanta DAS, Canton, MI (US); Ivan VUKOVIC, Birmingham, MI (US); John CARDILLO, Windsor (CA)

(21) Appl. No.: 15/710,490

(22) Filed: Sep. 20, 2017

(51) Int. Cl. G01C 21/34; H04W 4/04; H04W 28/16; H04L 29/08; H04W 88/02

(52) U.S. Cl. CPC G01C 21/34; H04W 4/04; H04W 88/02; H04L 67/12; H04W 28/16

(57) ABSTRACT

A computer-implemented method includes determining a path to a destination passing through a plurality of wireless access coverage areas corresponding to wireless networks selected based on the wireless networks meeting user defined network parameters, such that a projected amount of necessary data can be transferred as a vehicle travels the path. The method also includes determining an access plan for connecting the vehicle to the wireless networks as the vehicle travels along the path. The method further includes using the path as a navigation route and executing the access plan to connect the vehicle to the wireless networks according to the access plan.

### TECHNICAL FIELD

The illustrative embodiments generally relate to methods and apparatuses for route planning accommodating data transfer.

### BACKGROUND

With many vehicles on the road including telematics units and numerous passengers having cellular devices, strain on cellular networks is greater than ever. As autonomous vehicles become a reality, these vehicles may leverage massive amounts of infrastructure bandwidth to relay data back and forth between other vehicles and central servers. Dedicated short range connection (DSRC) transceivers, as well as other accessible Wi-Fi hotspots, may be available along certain route, but excessive usage of these points may limit available bandwidth.

Currently, a vehicle traveling a route may encounter one or more publicly accessible access points. This can include, but is not limited to, cellular towers, hotspots and other infrastructure. Use of certain of these access points may incur cost, or certain speeds of access may incur costs, and a user has no particular assurances that traffic on any given access point will not significantly limit that user's accessible bandwidth. Thus, if a user needs a good deal of data transfer to occur as the user travels to a destination, the user may either require an on-board dedicated connection with an assured bandwidth, or the user may have to simply rely on luck that the necessary connections and bandwidth will be available.

### SUMMARY

In a first illustrative embodiment, a system includes a processor configured to determine user data needs during a journey. The processor is also configured to determine a route, to a destination, including sufficient wireless network access coverage so that vehicle connection to available wireless networks permits determined data needs to be met and use the determined route as a navigation route

In a second illustrative embodiment, a computer-implemented method includes determining a route to a destination including at least a minimum amount of wireless network access, determinable based on known wireless access coverage of a plurality of wireless networks overlapping the route, to accommodate a user's data needs during travel and using the determined route as a travel route

In a third illustrative embodiment, a computer-implemented method includes determining a path to a destination passing through a plurality of wireless access coverage areas corresponding to wireless networks selected based on the wireless networks meeting user defined network parameters, such that a projected amount of necessary data can be transferred as a vehicle travels the path. The method also includes determining an access plan for connecting the vehicle to the wireless networks as the vehicle travels along the path. The method further includes using the path as a navigation route and executing the access plan to connect the vehicle to the wireless networks according to the access plan.

### BRIEF DESCRIPTION OF THE DRAWINGS

FIG. 1 shows an illustrative vehicle computing system;

FIG. 2 shows an illustrative route calculation process;

FIG. 3 shows an illustrative path selection process;

FIG. 4 shows an illustrative map of access point examples;

FIG. 5 shows a node-path between access points, usable for route determination; and

FIG. 6 shows an illustrative process for route modification.

### DETAILED DESCRIPTION

As required, detailed embodiments are disclosed herein; however, it is to be understood that the disclosed embodiments are merely illustrative and may be incorporated in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

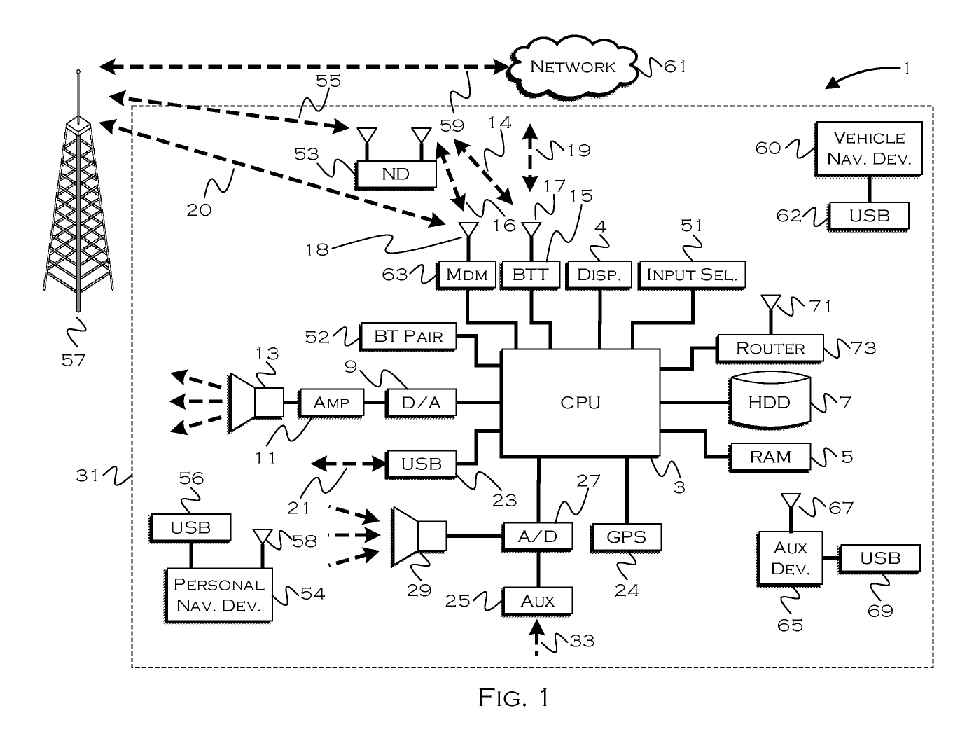

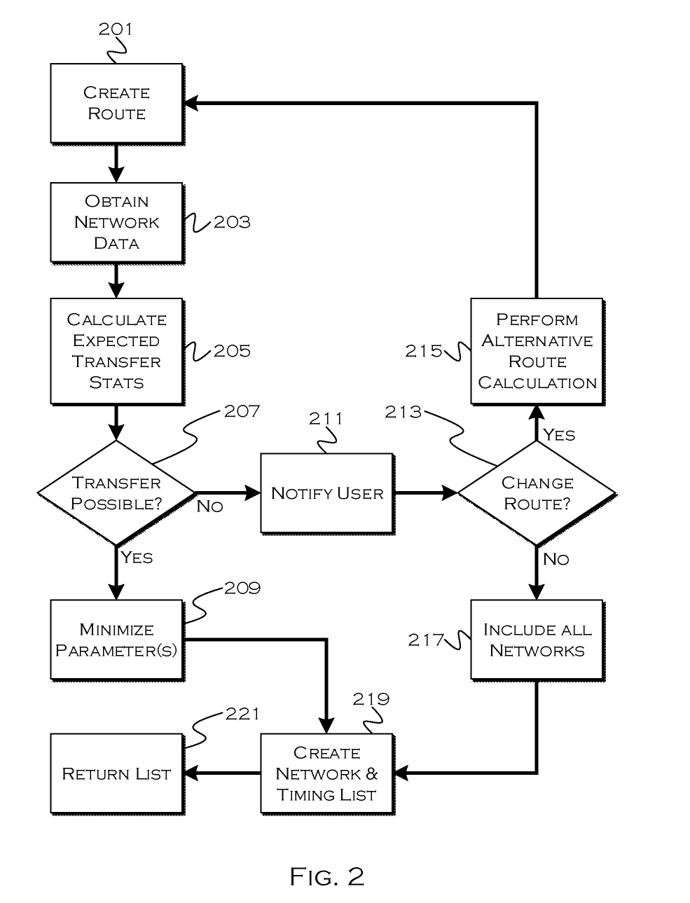

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touchscreen display. In another illustrative embodiment, the interaction occurs through button presses, spoken dialog system with automatic speech recognition, and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be transmitted to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device (hereafter referred to as ND) 53 can then be used to communicate 59 with a network 61 outside the vehicle 31 through, for example, communication 55 with a cellular tower 57. In some embodiments, tower 57 may be a Wi-Fi access point.

Exemplary communication between the ND 53 and the BLUETOOTH transceiver 15 is represented by signal 14.

Pairing the ND 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with ND 53. Alternatively, it may be desirable to include an onboard modem 63 having antenna 18 in order to communicate 16 data between CPU 3 and network 61 over the voice band. The ND 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, the ND 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. If the user has a data-plan associated with the nomadic device, it is possible that the data-plan allows for broadband transmission and the system could use a much wider bandwidth (speeding up data transfer). In yet another embodiment, the ND 53 is replaced with a cellular communication device (not shown) that is installed to vehicle 31. In still another embodiment, the ND 53 may be a wireless local area network (LAN) device capable of communication over, for example (and without limitation), an 802.11g network (i.e., Wi-Fi) or a Wi-Max network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a Wi-Fi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or a reasonable variation thereof.

While one driver may use a limited amount of data on any particular trip (such as to obtain navigation directions), another driver may want to stream media, transfer files, execute applications and generally use data at a near constant rate. The preceding examples of drivers are based primarily on current technologies, and once drive-assist or autonomous vehicles (AVs) exist in numbers, data uses for a variety of purpose may skyrocket.

If a certain amount of data bandwidth is reserved for vehicle communication (related to AV travel), the amount of bandwidth remaining for data streaming and data transfer may be severely limited at high-usage access points. Of course, logically, those points will probably exist at points where most traffic flows, which is also often the preferred route for most users. That is, if a highway connects points A and B, ninety percent or more of the traffic traveling between those two points may use the highway. Accordingly, access points adjacent to the highway may experience heavier usage. And, even if those access points are upgraded versions designed to handle high traffic, a better experience may still be achieved (from a data transfer perspective) by using a lesser version surface-road access point along an alternate route between A and B. If a user is more concerned about connectivity and data transfer (availability and/or cost) than travel time, the alternate route might be preferable. The illustrative embodiments propose solutions allowing a vehicle to accommodate a variety of connectivity-related factors when deciding on a proper route.

Any given user can define minimum transfer requirements or bandwidth needs, or this can be determined based on observed usage by that user (or for a group of known passengers). The user can also constrain variables with regards to alternate routes, so that a route that optimizes a particular user's preferences can be obtained. For example, in the preceding highway/alternate route example, the user may only prefer the alternate route if it takes no more than 20% longer to arrive at the destination. By allowing a user to define parameters that do not directly relate to travel (connectivity parameters, as opposed to fuel/time/traffic parameters, for example), the route calculation can accommodate a new level of user needs, and provide a certain class of data-concerned users with better travel options.

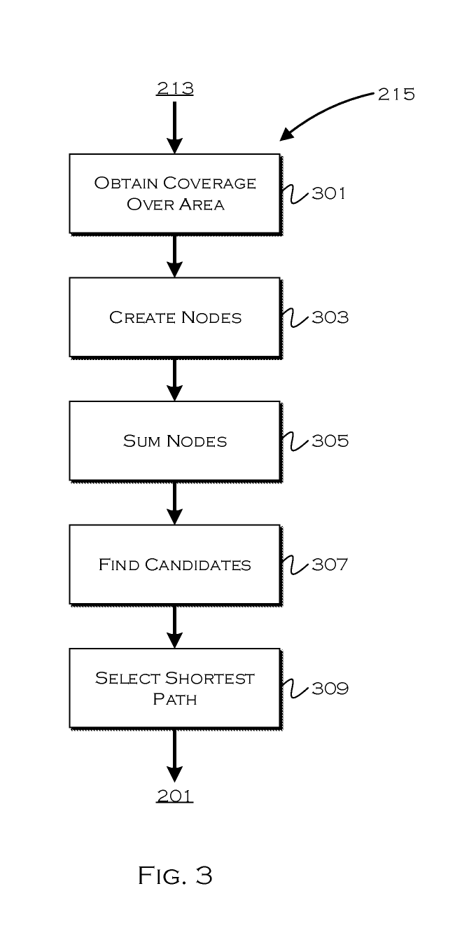

FIG. 2 shows an illustrative route calculation process. In this example, the process can determine a variety of route options with varied data accessibility opportunities. Based on user constraints and data constraints (known and projected), the process can provide an “optimal” route that accommodates the user's particular data needs as best as possible, while still providing suitable travel options with regards to more traditional travel-related parameters (time, fuel, distance, etc).

In this example, the process creates 201 a route between a location and a destination, which, in this example, starts as a travel-optimized route (the route that would be used in the absence of data constraints). Then, in this example, the process obtains 203 network data along the known route. This can include DSRC and other infrastructure access points, known public and pay-for-use hotspots, cellular towers, etc. Coverage of points and transfer rates under varied conditions can be gathered based on observed usage from a variety of accessing-vehicles over time, so the system can have a set of parameters for coverage and bandwidth, under current and projected conditions, for each access point along the route.

Based on publicly available data and projected coverage and transfer rates, the process calculates 205 expected transfer stats. The process then compares these statistics to known data transfer needs to determine 207 if required data transfer is expected to be possible along the chosen route. Actual data transfer needs can be user-indicated and/or can be projected based on observations made by the process over time. In some examples, the route will consider a total volume of data needed to be transferred, and whether all the encountered access points along the route can accommodate this data. In other examples, certain minimum bandwidth constraints may need to be regularly or persistently available. The particulars may depend on the needs of a given user.

If data transfer according to a user's needs is not available along the current route, the process may notify 211 the user and provide an option to chose an alternative route. If the user elects 213 to change the route, the process may use known regional access point data to calculate 215 a new route and repeat the determination relating to necessary data transfer. If the user indicates that the current route is acceptable, the process may generate 217 an instruction for the onboard data transfer module to use all available networks encountered to facilitate requested data transfer, and create 219 a list of expected access points and access time instructions, which, in this case, would be all access points and maximum access time.

If the current route can accommodate projected needs, and has more access point coverage than necessary, then the process can minimize 209 transfer parameters according to user preferences. For example, one user may be cost-agnostic, and may prefer maximum speed of transfer or maximum speed of transfer-completion for a requested file. This user would not care if costly access points were used, and/or how much time was spent using those points. On the other hand, another user may only want free access points, provided that the necessary coverage can be obtained, and this user would only want to use the pay-per-use access points for the minimum amount of time needed to complete any projected transfers.

In this manner access point usage can be optimized when there is more than sufficient coverage available. If a user needs a minimum amount of transfer and passes a point on a route where the remaining transfer can be achieved using the present access point plan (e.g., an access point was down or bandwidth was lower than expected), the process can always adjust the usage instructions to accommodate the changing needs. The process builds 219 a list of networks and when or how long those networks are to be used, and then the process returns 221 a list along with the route.

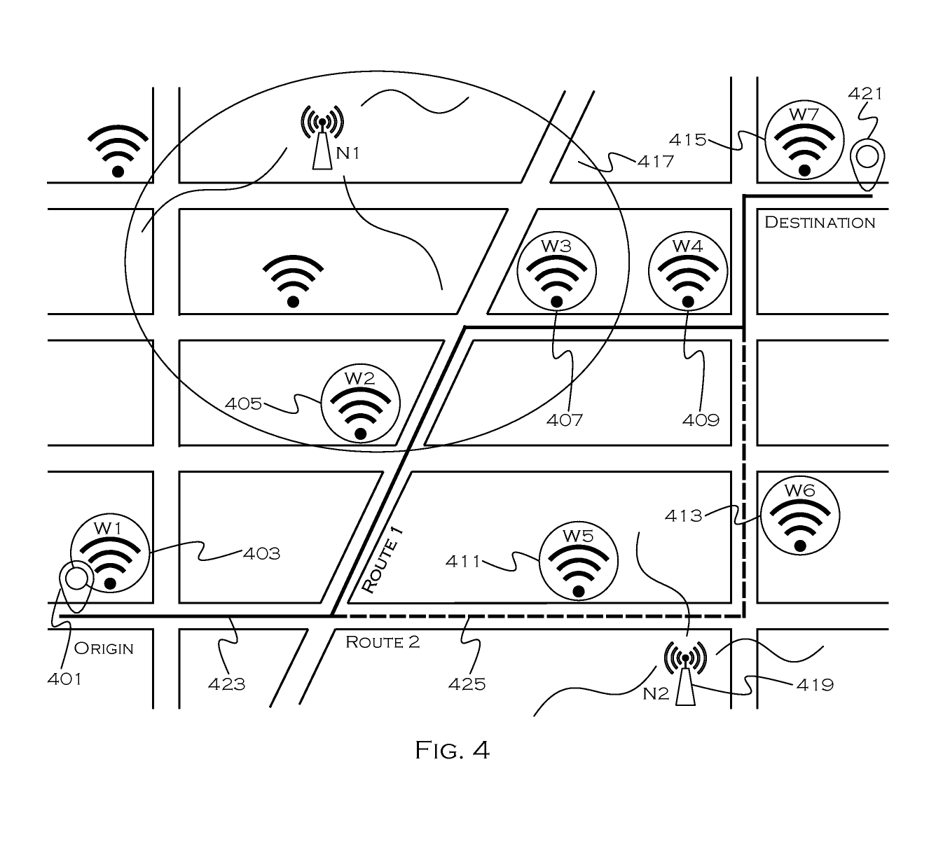

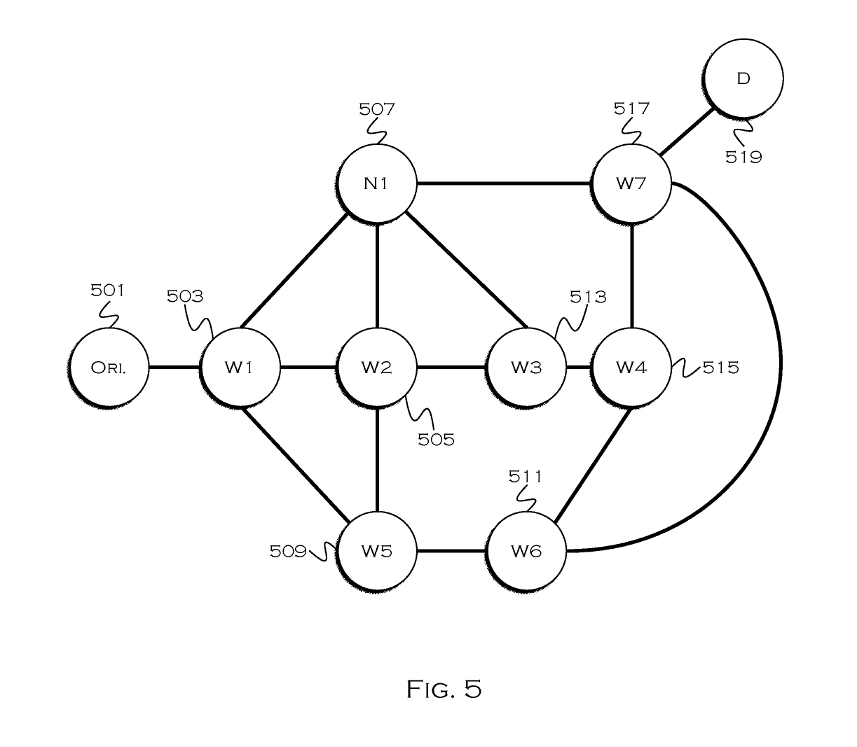

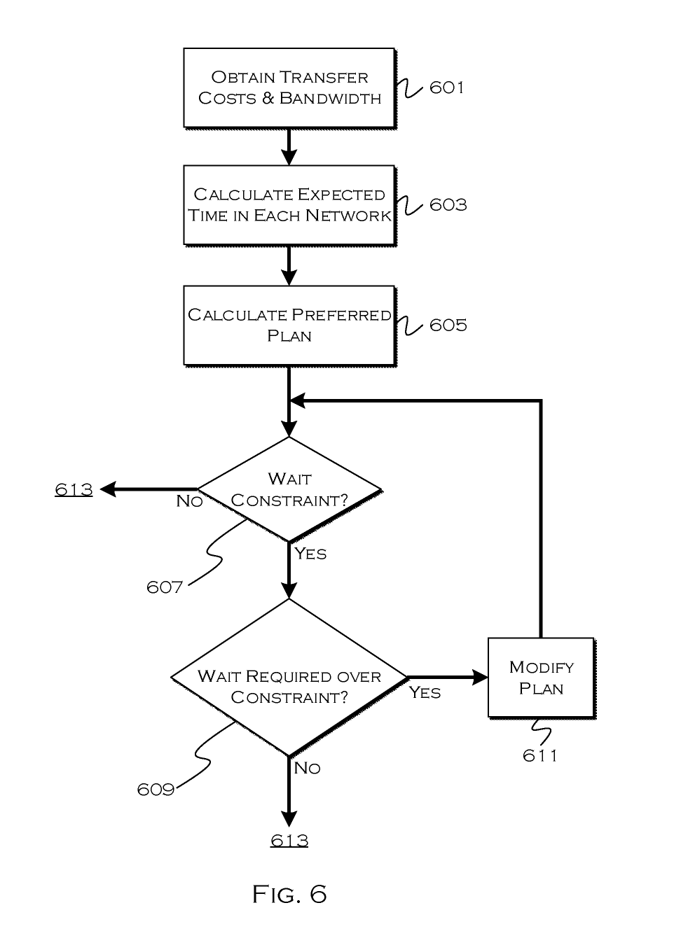

FIG. 3 shows an illustrative path selection process. This is just one example of how a process can select paths that have a minimum required amount of coverage, or meeting other parameters. This is purely an illustrative example of just one suitable process, and is not intended to limit the scope of the invention thereto. Rather, this demonstrates, in conjunction with FIG. 5, an example of how pathing methodology can accommodate consideration of connectivity parameters.

In this example, the process 215 obtains 301 coverage over a given area between a current location and destination. Just as a mapping program does not consider every conceivable route (such as those going backwards), the process can consider connectivity coverage in an area similar to the area considered for route consideration, or a smaller or larger range as appropriate. In one example, the process starts with the route-considered area, and then can scale out or in depending on how much coverage is available (for an area blanketed by coverage, the process may scale in to consider routes closer to the optimal travel-related route, for an area with minimal coverage the process may scale out to attempt to capture more access point coverage, although this would conceivably result in a potentially slow or long route).

For each access point, the process creates 303 a node indicating the parameters (bandwidth, cost, speed, etc) of the access point. The nodes are connected by proximity pathways, where each node “connects” to all other proximate nodes along a route including no other nodes (i.e., if there is a travelable path on roads between two coverage areas, that does not include other coverage, then those two nodes connect). In some examples, other parameters such as forward travel towards a destination within a 180 degree arc may constrain the node connections, to prevent long looping-back routes from creating too many node connections.

Then, in this example, the process can sum 305 each series of nodes connecting the origin to the destination. A list of such sums can indicate the total bandwidth, data amount, expected cost, etc of a given path. Since some roads may include more coverage than other roads, meaning approaching a node from one direction may have a different effect from approaching the node from another direction or bisecting coverage along a different portion of a coverage area, the process can treat a single node as a series of connected nodes according to the locations and amounts of individual roadway covered by the node. Again, this is purely for illustration only, a number of pathing algorithms can be modified to accommodate the variables considered by the illustrative embodiments in accordance with the overall techniques taught by the illustrative examples.

From the list of possible node combinations leading to a destination, the process selects 307 one or more candidate routes meeting as many of the data-related constraints as possible. If several routes meet all the constraints, and others meet fewer constraints, it is possible to only select the routes meeting the most data related constraints. On the other hand, it is possible to select all routes meeting at least some constraints from a group of routes that meet travel-related constraints as well. That is, data can be given priority over travel parameters or weighed against travel parameters. And, of course, travel parameters can similarly be given priority over data.

From the selected candidate routes meeting the requisite number of constraints (data or travel related), the process selects 309 the fastest route (or other optimization parameter, such as the “cheapest” data related route). This route is then the route the vehicle uses to travel, and the route can be adapted while traveling if one or more data nodes is not performing as needed or expected.

FIG. 4 shows an illustrative map of access point examples. In this example, the map covers a region between an origin 401 and a destination 421. This example shows two possible paths 423 and 425. Route 2 (along 425) does not pass near a cellular tower, and may have less coverage, depending on the signal ranges of 411 and 413 (wireless access points W5 and W6). Route 1 along 423 passes through cellular N1 having a large coverage range 417. This may be a slower connection than that provided by points 405 and 407, but it has the advantage of covering a large portion of 423 and likely being free (or free based on a data plan). Use of 405 or 407 may incur a cost.

Both routes will have access to the origin node 403 (W1) and the destination node 415 (W7). Route 1 has access to nodes W2 405, W3 407, W4 409 and N1 417. Route 2 has access to nodes W5 411, W6 413 and cellular N2 419. Choice of nodes and time of use of each node may depend on the route chosen and any data-constraints specified by a user or by OEM preferences. Also, as previously noted, certain routes 423 will spend more time near a node, such as W4, than other routes 425, and so W4 could conceivable be represented by multiple nodes in FIG. 5.

FIG. 5 shows a node-path between access points, usable for route determination. In this example, all routes begin at the origin node 501. Since W1 is an access point covering the origin node, all routes to a destination have access to the W1 access point 503. From 503, a user either encounters N1 507, W2 505 or W5 509 next. In this example, the range of the Wireless (W) access nodes encompasses portions of the adjacent streets, so certain routes hit N1 first and certain routes hit W2 first. Going along path 425, W5 is the first next access point. This node diagram includes routes other than 423 and 425.

As can be seen in FIG. 4, vehicles encountering N1 may encounter W2, W3 513 or W7 517 next. Vehicles encountering W2 may encounter N1, W3 or W5 next, but this is assuming that there is at least some overlap between signals of W2 and W3, otherwise the path therebetween would only run thorough N1.

Vehicles taking either the 423 or 425 routes would hit W4 515 before hitting W7 at the destination 519. Vehicles on route 425 would encounter W6 before encountering W4.

By using a search such as this, a path of nodes between an origin and destination along a variety of routes can be determined. For a given route, possible access times (based on coverage) can be determined for each access point, and the system can determine if the access points comprising the route can accommodate given data needs. For example, a system desiring maximum high speed access might consider a route from W1 to W2 to W3 to W4 to W7, which should maximize Wi-Fi coverage. But, a large gap between nodes could mean that it would be better to use a path through N1 as well, since that node has a wider coverage area. Parameters could also be assigned to the connections between nodes if appropriate, representing, for example, distances with no coverage between nodes. In an instance such as this, a path can be determined based on both node and path parameters. Again, this is merely an illustrative example of how a path of nodes could be calculated.

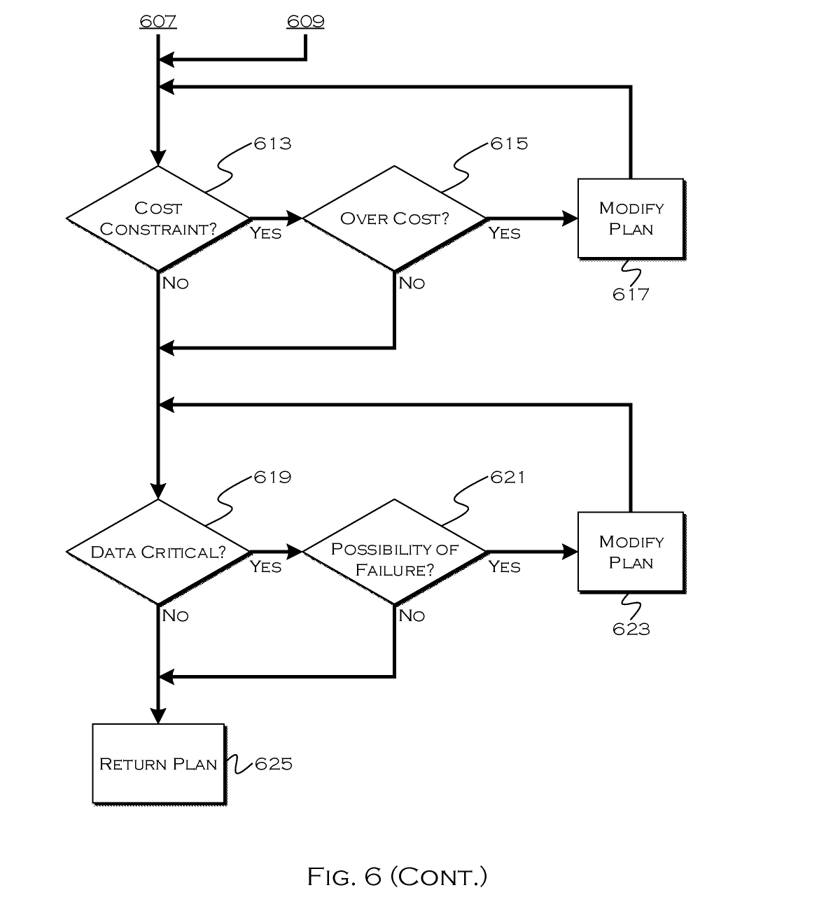

FIG. 6 shows an illustrative process for route modification. In this example, the process determines if a selected plan of node access meets any user defined data-constraints. This is an example of a process that could be used, once a route is selected, to determine a plan for which networks to access and when to access them, in order to ensure coverage meeting predicted or known user needs.

In this example, the process obtains 601 transfer costs and bandwidth limitations for each network expected to be encountered along a chosen route. This can include current statistics (if available), and/or projected statistics. Data providers could also discount data if usage was low, so using real-time cost data might identify certain savings that can be temporarily achieved by accessing certain nodes.

Next, the process calculates 603 an expected time in each network, based on user criteria and known or projected needs. Users who are cost agnostic may prefer maximum time in the fastest networks, users who are speed agnostic may prefer maximum time in the cheapest networks. Based on a known or projected data/coverage need, the process determines an appropriate amount of connectivity with each available access point (as accommodated by signal coverage along the chosen route). In order to fulfil certain needs, the process may require “waits” at certain points along a route, to keep the vehicle in network coverage range for a certain minimum time. If, for example, network covers a stoplight, the possibility of stopping can be considered when factoring in “waits,” as can the possibility of being slowed or stalled in traffic at certain points. On the other hand, if a route was open all the way to the destination, without stops, the process may not encounter sufficient waiting, and therefore a route plan may include some amount of “required” or “recommended” delay while in range of certain networks. All of this planning information is aggregated 605 into a projected access plan.

Since the user may certain behavioral constraints configured, the process takes the projected plan and compares the plan to the user constraints. For example, if a wait constraint exists 607, the user may have specified a maximum amount of time the user is willing to “wait” if a route is otherwise unimpeded. No wait constraint means that the user is willing to slow or stop a vehicle in accordance with a planned wait if a certain amount of connectivity is needed to complete a transfer. Based on the plan, if any projected wait time is over the wait constraint 609, the process will modify the plan 611, to reduce wait times (which may mean connecting to a different network for a longer time, which may increase cost or use different bandwidths). The modified plan is then reconsidered, until all wait times are below the constraints (or lowered to below the constraints, if all other access times are maximized).

In a similar manner, the process determines if there is a cost constraint 613, and whether or not individual or total access costs are over 615 any specified constraints (either or both could be constrained). Again, the process modifies 617 the plan if any cost constraint is exceeded.

As will be apparent, in networks where access is limited, it may not be possible to accommodate wait, cost and other constraints while still providing a minimum level of access. In these situations, the system (based on OEM or user parameters) can choose which constraints to prioritize and which to “ignore” if some or all of any constraint must be ignored. This can include ignoring the total projected amount of transfer, if that is the least important thing to the user (e.g., the user never wants to wait and never wants to pay for data, so the route would then only use free access points with no waiting).

In this example, cost has priority over waiting, which means that the modifications to accommodate cost may cause a wait that was previously unacceptable, but because the cost is more important, the wait may be re-incurred in the interest of reducing cost.

Finally, in this example, the process considers critical data transfer to be the highest priority. If there is critical data 619, the process determines 621 if the current plan has any likely chance (barring, for example, total network failure or natural disaster) of failure to complete. That is, if the total amount of data is 100 MB, and the plan is set to accommodate exactly 100 MB of transfer, then any lapse in coverage, reduced bandwidth or other error would fail to complete the transfer. On the other hand, if the plan accommodates 200 MB of transfer, a sufficient threshold of error-tolerance may be built in to accommodate unexpected lapses. If there is insufficient threshold of over-coverage or over-access accommodated for critical data, the process may again modify 623 the plan to include additional coverage earlier along a route, which should increase the chance of accommodating the data transfer by the time the route is completed. The process then returns 625 a finalized plan.

In an autonomous vehicle application, the process may consider “critical data” to be any and/or all data that helps the vehicle travel, and there may be a significant amount of critical data or connectivity needed. In these examples, the critical data modifications may cause both the waiting and cost parameters to be exceeded, but those parameters give way to the critical need because without the data, the vehicle simply cannot travel.

Through the illustrative embodiments, the examples shown illustrate how route planning can accommodate data transfer parameters and needs, helping to ensure that a user can reach a destination achieving any level of connectivity that the user desires (if such connectivity is available on at least one route also meeting user travel constraints). This lets users plan routes based on more than simply travel data alone. Such route planning also allows vehicles such as AVs to plan routes to ensure a certain amount of necessary data coverage along the route, until such time as all routes have sufficient data coverage to permit AV travel.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined in logical manners to produce situationally suitable variations of embodiments described herein.

What is claimed is:

1. A system comprising:
a processor configured to:
determine user data needs during a journey;
determine a route, to a destination, including sufficient wireless network access coverage so that vehicle connection to available wireless networks permits determined data needs to be met; and
use the determined route as a navigation route.

2. The system of claim 1, wherein the processor is further configured to determine a connection plan defining a set of available wireless networks and intended connection durations to each network in the set, and wherein the processor is configured to execute the connection plan as a vehicle travels.

3. The system of claim 2, wherein the processor is further configured to determine a necessary wait period for at least one of the networks in the set, defining a projected necessary waiting time within coverage of the at least one network to accommodate the intended connection duration to the at least one network.

4. The system of claim 3, wherein the processor is configured to determine if the necessary wait period exceeds a user-defined wait constraint defining a maximum wait time.

5. The system of claim 4, wherein the processor is configured to determine a new connection duration for a different wireless network in the set, other than the at least one network, when the necessary wait period exceeds the user-defined wait constraint.

6. The system of claim 2, wherein the processor is further configured to determine a projected data transfer cost for use of each of the networks in the set for the intended connection duration, based on expected data transfer during the intended connection duration.

7. The system of claim 6, wherein the processor is further configured to determine if the projected data transfer cost exceeds a user-defined maximum cost.

8. The system of claim 7, wherein the processor is further configured to determine a new intended data transfer amount for a network in the set having a lower data transfer cost than a network for which the projected data transfer cost exceeds the user-defined maximum cost.

9. The system of claim 8, wherein the determination of the new intended data transfer amount includes a determination of a new intended connection duration for the network in the set having the lower data transfer cost.

10. The system of claim 2, wherein the processor is configured to determine the connection plan to accommodate at least a predefined threshold amount of data above the determined data need for any data determined to be critical data, based on user-indication or predefined critical data, by the processor.

11. A computer implemented method comprising:
determining a route to a destination including at least a minimum amount of wireless network access, determinable based on known wireless access coverage of a plurality of wireless networks overlapping the route, to accommodate a user's data needs during travel; and
using the determined route as a travel route.

12. The method of claim 11, further comprising:
determining a connection plan defining which of the plurality of wireless networks to access and for what duration to access each accessed network; and
executing the connection plan as a vehicle travels along the determined route.

13. The method of claim 12, wherein the determining a connection plan includes determining wait times, defining necessary projected delays within a given network coverage area for the networks in the connection plan.

14. The method of claim 13, wherein the determining wait times includes adjusting the connection plan defining which networks to access and for what duration to access each network to keep the wait times below a user-defined maximum.

15. The method of claim 12, wherein the determining a connection plan includes determining projected data transfer costs, projecting a total cost for expected data transfer at a given network in the connection plan when following the connection plan.

16. The method of claim 15, wherein the determining projected data transfer costs includes adjusting the connection plan defining which networks to access and for what duration to access each network to keep projected data transfer costs below a user-defined total cost.

17. A computer-implemented method comprising:
determining a path to a destination passing through a plurality of wireless access coverage areas corresponding to wireless networks selected based on the wireless networks meeting user defined network parameters, such that a projected amount of necessary data can be transferred as a vehicle travels the path;
determining an access plan for connecting the vehicle to the wireless networks as the vehicle travels along the path; and
using the path as a navigation route and executing the access plan to connect the vehicle to the wireless networks according to the access plan.

18. The method of claim 17, wherein the user defined network parameters include at least one of:
wait times, defining maximum vehicle waits within one or more network coverage area;
bandwidth constraints defining minimum bandwidth requirements for each of the wireless networks; or
costs, defining maximum transfer costs or total costs.

19. The method of claim 17, wherein the access plan defines expected connection durations and expected data transfer amounts.

20. The method of claim 17, wherein the method includes determining the access plan following exiting one of the plurality of wireless access coverage areas when a projected amount of data remaining exceeds an expected amount of data remaining according to a previously determined access plan.
